(19) United States
(12) Patent Application Publication
(10) Pub. No.: US 2016/0347449 A1
(43) Pub. Date: Dec. 1, 2016

(54) Kite Frame Assembly

(71) Applicant: Ching-Chen Huang, New Taipei City (TW)

(72) Inventor: Ching-Chen Huang, New Taipei City (TW)

(21) Appl. No.: 14/720,836

(22) Filed: May 25, 2015

(51) Int. Cl. B64C 31/06

(52) U.S. Cl. CPC B64C 31/06

(57) ABSTRACT

The kite frame assembly contains a kite frame, a number of limiting elements, and a number of fastening elements. The kite frame contains a main stick, a number of connection elements movably configured along the main stick, and a number of auxiliary sticks joined to the main stick. The limiting elements are movably configured along the main stick; and the fastening elements are fixedly configured along the main stick. Each connection element is sandwiched between a pair of limiting elements, which in turn sandwiched between a pair of fastening elements. As such, each connection element is movably limited to an appropriate position range along the main stick and enhanced flexibility and convenience is achieved when assembling a kite.

### BACKGROUND OF THE INVENTION

(a) Technical Field of the Invention

The present invention is generally related to kites, and more particular to a kite frame assembly.

(b) Description of the Prior Art

For conventional kite frame assemblies, usually there is a main stick and a number of connection elements are threaded by the main stick. Each connection element is limited by two locking rings so that it is slidable along the main stick within the confinement of the locking rings. Then auxiliary sticks and aerodynamic surface are put together so as to complete the kite's assembly.

In the above assembly process, when adhesive (usually instant adhesive) is applied to the locking rings, excessive adhesive often overflows to the connection elements and the connection elements are as such fixed to the main stick. Losing the leeway provided by the slidable connection elements, the assembly of the kite becomes more difficult and less flexible. The assembled kite usually has a poor balance as the connection elements cannot be adjusted as required.

### SUMMARY OF THE INVENTION

A main objective of the present invention is to provide a novel kite frame assembly where appropriate leeway is preserved after connection elements are movably configured on a main stick of the kite frame assembly.

To achieve the above objective, the kite frame assembly contains a kite frame, a number of limiting elements, and a number of fastening elements. The kite frame contains a main stick, a number of connection elements movably configured along the main stick, and a number of auxiliary sticks joined to the main stick. The limiting elements are movably configured along the main stick; and the fastening elements are fixedly configured along the main stick. Each connection element is sandwiched between a pair of limiting elements, which in turn sandwiched between a pair of fastening elements.

In one embodiment, each connection element has a central through hole and two laterally and adversely extended sleeves.

In one embodiment, the main stick is threaded through the connection elements through their central through holes; and the auxiliary sticks are joined to the sleeves of the connection elements.

In one embodiment, each limiting element has a ring or C-like shape.

In one embodiment, each fastening element has a ring or C-like shape.

In one embodiment, each fastening element is fixed to the main stick through adhesive.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 to 4 are perspective diagrams showing the assembly process of a kite frame assembly according to an embodiment of the present invention.

FIG. 5 is a schematic diagram showing the kite frame assembly of FIGS. 1 to 4 after its assembly.

FIG. 6 is a schematic diagram showing a kite with the kite frame assembly of FIG. 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

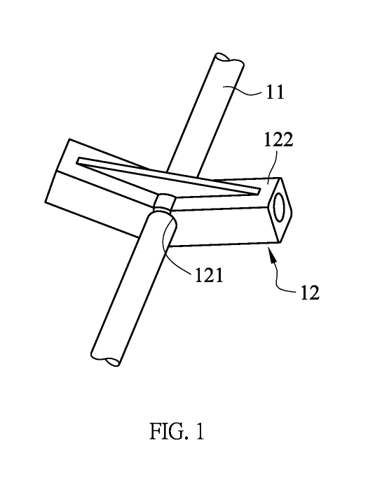

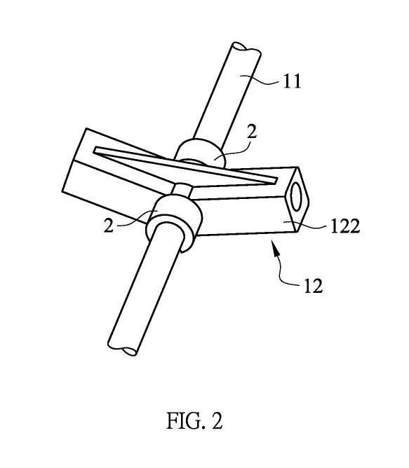

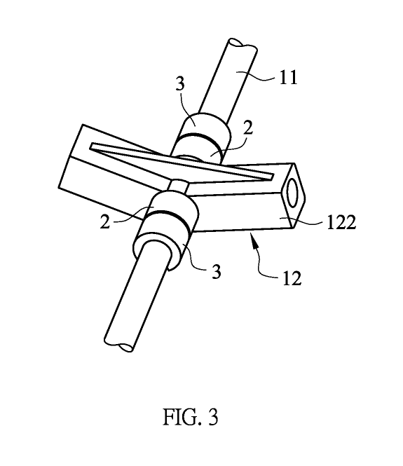

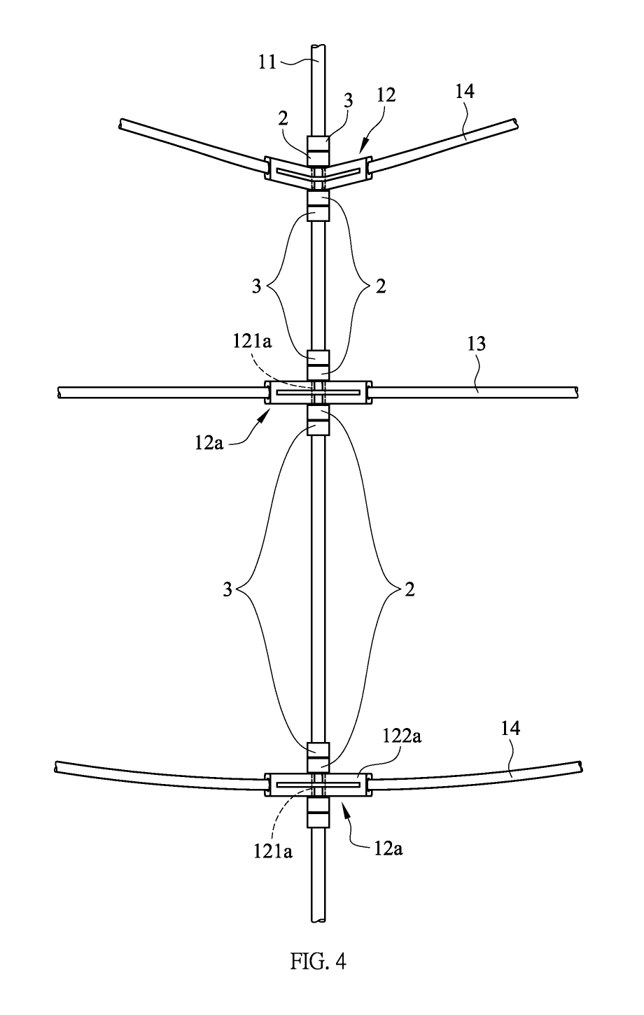

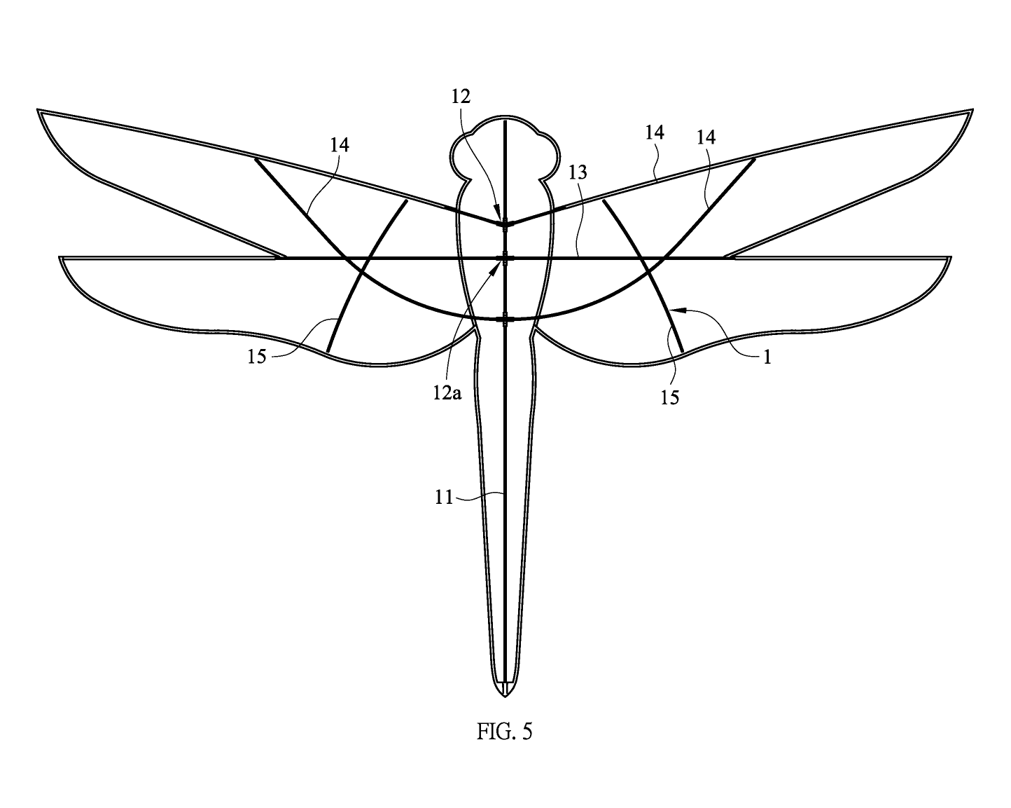

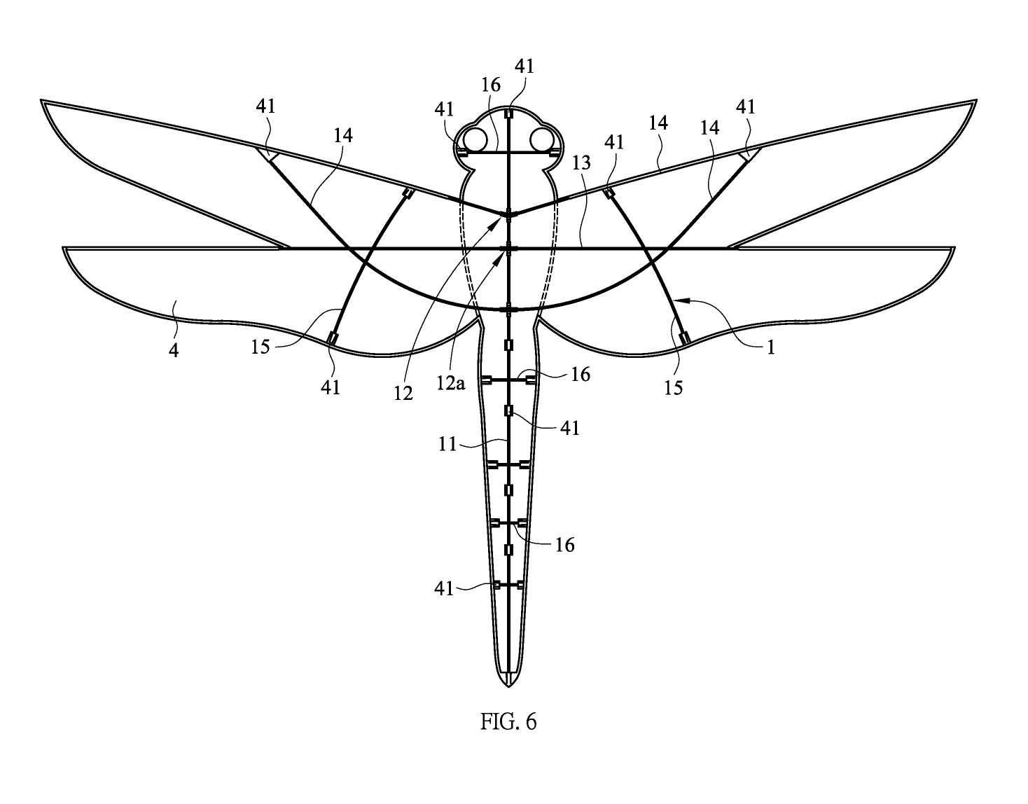

As shown in FIGS. 1 to 6, a kite frame assembly according to an embodiment of the present invention contains a kite frame 1, a number of limiting elements 2, and a number of fastening elements 3.

The kite frame 1 contains a main stick 11, a number of connection elements 12 and 12a movably configured along the main stick 11, and a number of first, second, third, and fourth auxiliary sticks 13, 14, 15, and 16. Each connection element 12 or 12a has a central through hole 121 or 121a, and two laterally extended sleeves 122 or 122a.

The limiting elements 2 are also movably configured along the main stick 11 and each connection element 12 or 12a is sandwiched between two limiting elements 2. Each limiting element 2 has a ring or C-like shape. In the present embodiment, each limiting element is ring-shaped.

The fastening elements 3 are fixedly configured along the main stick 11 and each set of a connection element 12 or 12a and two pressing limiting elements 2 is further sandwiched between two fastening elements 3. Each fastening element 3 presses against a limiting element 2, and has a ring or C-like shape. In the present embodiment, each fastening element 3 is ring-shaped, and is adhered to the main stick 11.

To assembly a kite, the main stick 11 is threaded through the connection elements 12 and 12a through their central through holes 121 and 121a, the limiting elements 2, and the fastening elements 3. The connection elements 12 and 12a, the limiting elements 2, and the fastening elements 3 are arranged so that each connection element 12 or 12a is positioned between a pair of limiting elements 2, which in turn is pressed between a pair of adhered fastening elements 3. Please note that, as adhesive is applied to the fastening elements 3, excessive adhesive only permeates to the neighboring limiting elements 2, without affecting the connection element 12 or 12a. After the connection elements 12 or 12a are positioned appropriately along the main stick 11 as described, the first and second auxiliary sticks 13 and 14 are plugged into the sleeves 122 and 122a, and an aerodynamic surface 4 is attached to the kite frame assembly 1. The surface 4 contains a number of connection elements 41 along its edges, and the third and fourth auxiliary sticks 15 and 16 are plugged into the connection elements 41 so as to provide additional support to the surface 4.

As the connection elements 12 and 12a are slidable within appropriate ranges along the main stick 11, when the surface 4 and the auxiliary sticks 13, 14, 15, 16 are put together, the connection elements 12 and 12a has enough leeway so that the kite frame assembly 1 can be properly balanced.

When the limiting and fastening elements 2 and 3 are ring-shaped, each connection element 12 or 12a, and their accompanying limiting and fastening elements 2 and 3 are threaded sequentially on the main stick 11. When the limiting and fastening elements 2 and 3 are C-like shaped, all connection elements 12 and 12a can be configured on the main stick 11 altogether, the limiting and fastening elements 2 and 3 are then placed around each connection elements 12 and 12a subsequently.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A kite frame assembly, comprising:
a kite frame comprising a main stick, a plurality of connection elements movably configured along the main stick, and a plurality of auxiliary sticks joined to the main stick;
a plurality of limiting elements movably configured along the main stick; and
a plurality of fastening elements fixedly configured along the main stick;
wherein each connection element is sandwiched between a pair of limiting elements, which in turn sandwiched between a pair of fastening elements.

2. The kite frame assembly according to claim 1, wherein each connection element has a central through hole and two laterally and adversely extended sleeves.

3. The kite frame assembly according to claim 2, wherein the main stick is threaded through the connection elements through their central through holes; and the auxiliary sticks are joined to the sleeves of the connection elements.

4. The kite frame assembly according to claim 1, wherein each limiting element has a ring or C-like shape.

5. The kite frame assembly according to claim 1, wherein each fastening element has a ring or C-like shape.

6. The kite frame assembly according to claim 5, wherein each fastening element is fixed to the main stick through adhesive.
